(19) United States
(12) Patent Application Publication
(10) Pub. No.: US 2002/0051464 A1
(43) Pub. Date: May 2, 2002

(54) Quality of transmission across packet-based networks

(76) Inventors: Tam Wee Sin, Singapore (SG); Mohd Noor Halim, Singapore (SG); Janardhana Reddy Naredula, Singapore (SG); Mao Hui Fang, Singapore (SG); Kevin Payne, Gardenvale (AU)

Correspondence Address: PENNIE AND EDMONDS, 1155 AVENUE OF THE AMERICAS, NEW YORK, NY, 100362711

(21) Appl. No.: 09/929,089

(22) Filed: Aug. 14, 2001

(30) Foreign Application Priority Data
Sep. 13, 2000 (SG) SG 200005204-3

(51) Int. Cl. H04J 3/16

(52) U.S. Cl. 370/466; 370/389

(57) ABSTRACT

A method of audio (as defined herein) transmission over a network where audio frames are sent in UDP packets, wherein the audio frames are overlapped by at least one for each UDP packet. A method of monitoring quality of service information, and a packet for this, are also disclosed.

### FIELD OF THE INVENTION

This invention relates to methods to improve the quality of any time sensitive, real time media that is transmitted across packet-based networks such as, for example, the Internet.

### DEFINITION

Throughout this specification this reference to audio is to be taken as including a reference to telephony, video, broadcast audio, and broadcast video.

### BACKGROUND TO THE INVENTION

Unlike the conventional Public Switched Telephone Network (PSTN) where telephone calls are make over dedicated circuit-switch networks, Voice Over Internet Protocol (VoIP) calls are established over packet-switched (Internet Protocol) IP networks. Such networks can be private networks or public networks.

For phone-to-phone VoIP, there are originating and terminating gateways for the caller and callee respectively. Locations for both gateways can be selected to ensure good Internet connectivity. A managed private network can be used for the connection although it can also be over a public network. For public networks, strategic locations are normally selected for good network performance so that factors such as, for example, delay and packet loss can be controlled. However, the price of these conditions is a higher cost. Premier locations that are near to the Internet backloone are normally selected for the gateways. The cost of a managed network (such as, for example, leased lines among the network of gateways) is also high. This is especially so for international connectivity.

However, for PC-to-Phone VoIP calls, there is only a terminating gateway for terminating calls to the callee's PSTN telephone. The call originates from a Personal Computer (PC). Such PCs are normally connected to the Internet using a modem via their Internet Service Provider (ISP). Therefore, the originating point of a PC-to-Phone VoIP call can be located anywhere in the public Internet. It can be close to the Internet backbone, or far away from the backbone. As a result, the quality of the Internet connection varies accordingly. It may have a long network delay to the terminating gateway. There can also be high packet loss due to network congestion. Jitter between successive IP packets can also be high. Such factors can affect the audio quality of VoIP calls.

Besides delay, packet loss and jitter, another common problem with the public Internet is that occasionally the connectivity may be totally lost. The terminating gateway may not be able to be reached at all. As a result, the VoIP call cannot be established or may terminate unexpectedly.

In a VoIP network, problems are usually transient and without long term monitoring, it is impossible to detect or track down the cause of the problem.

In VoIP calls, audio is sent in User Data Protocol (UDP) packets. The audio frame can be sent as one frame per packet, or multiple frames per packet. For example:

One audio frame per UDP packet:

|UDP Header|Frame 1|→

|UDP Header|Frame 2|→

|UDP Header|Frame 3|→

Three audio frames per UDP packet:

|UDP Header|Frame 1|Frame 2|Frame 3|→

|UDP Header|Frame 4|Frame 5|Frame 6|→

|UDP Header|Frame 7|Frame 8|Frame 9|→

In this manner, when a UDP packet is lost, the audio frame or frames will be lost, causing discontinuity in the real time media stream. This affects the audio quality (e.g. due to breaks in the conversation).

It is therefore the principal object of the present invention to provide methods to improve the quality of and time sensitive, real time media that is transmitted across a packet-based network such as, for example, the Internet.

### SUMMARY OF THE INVENTION

With the above and other objects in mind, the present invention provides a method of audio (as defined herein) transmission across a packed—based network where audio frames are sent in UDP packets, wherein the audio frames are overlapped by at least one for each UDP packet.

The number of overlapped audio frames may be any suitable number such as, for example, one or two. The extent of overlap may be determined in response to a detection of high packet loss.

The transmission may be in a standard format from an originating gateway to an originating converter, which converts the transmission to the overlapped format. Preferably, the originating converter is close to the originating gateway. More preferably, they are in the same network.

Prior to arrival at a terminating gateway the audio frames are converted to the standard format by a terminating converter. Preferably, the terminating converter is close to the terminating gateway. More preferably, they are in the same network.

The present invention further provides the deployment of a number of nodes strategically placed around the Internet. There may be as few as one node, or as many nodes as required. The nodes monitor the quality of IP connectivity to selected destinations and provide data for historical analysis.

This long-term historical data can then be used to:

a) provide a basis for determining when problems have occurred;

b) analyse historical problems to determine the root cause;

c) detect information about problems as they occur and gather additional information for subsequent analysis;

d) alert staff about problems as they occur; and

e) improve the Quality of Service (QoS) of calls by such means as rerouting IP packets, sending redundant frames and or packets or setting up future calls via an alternative destination gateway.

The present invention also provides a method of telephony on a network where audio (as defined herein) frames are sent in UDP packets, wherein at least one monitoring station is provided in the network, and wherein the at least one monitoring station periodically sends at least one packet to at least one destination of interest to obtain quality of service information.

The at least one monitoring station may perform a trace route analysis at required intervals, and the quality of service information may be periodically uploaded to at least one central side for amalgamation of data.

Preferably, the quality of service information obtained from a first packet sent to a first destination is compared with packet historical values for the first destination and, if a discrepancy above a predetermined threshold is obtained, a trace route analysis is performed for the first destination. The results of the trace route analysis may be compared to trace route historical values and, if the results exceed a present level of discrepancy, traffic to the first destination can be sent over the network by a different route.

Advantageously, the at least one packet has a set-up substantially the same as the set-up of a standard packet for voice over Internet protocol calls, and the at least one packet may be of the same size as those used for voice over Internet protocol calls. Furthermore, the at least one packet may be in the same user data protocol port range as those used for voice over Internet protocol calls. If desired, there may be a plurality of packets sent at a controlled rate to emulate the rate of packets of voice over Internet protocol packets.

In one form the first destination is capable of measuring jitter between packets arriving from the at least one monitoring station.

The quality of service information obtained may include one or more selected from the list consisting of:

a) the maximum round trip time;

b) the number of packets lost;

c) the round trip jitter;

d) the number of packets received out of sequence; and

e) the number of consecutive packets lost.

Prior to sending the at least one packet, the at least one monitoring station may send a call set-up request the first destination may keep statistics on the packets it has received and may forward those statistics to the at least one monitoring station.

In another form the present invention provides packet to be used to provide quality of service information about a telecommunications network, the packet having a set-up substantially the same as the set-up of a standard packet for voice over Internet protocol calls.

The packet may be of the same size as the standard packet, and may be in the same user data protocol port range as the standard packet.

The packet may be sent over the telecommunications network to emulate the standard packet and may evaluate a typical packet in a real time media stream.

### DESCRIPTION OF THE DRAWINGS

In order that the invention may be understood and readily put into practical effect, there shall now be described by way of non-limitative example only preferred embodiments of the present invention, the description being with reference to the accompanying illustrative drawings in which:

FIG. 1 is a schematic representation of the system architecture;

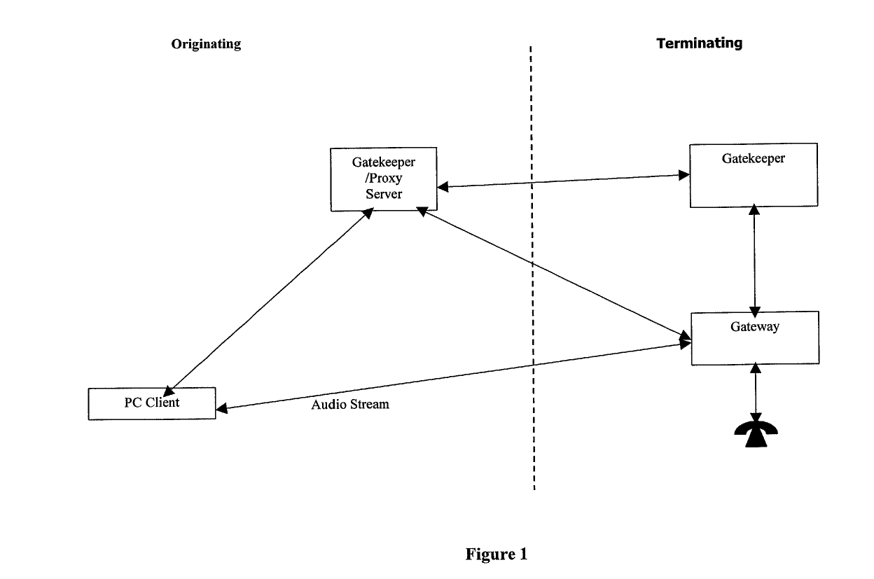

FIG. 2 is a schematic representation of a network monitoring system;

FIG. 3 is a graph showing data obtained from a network; and

FIG. 4 illustrates QoS routing.

### DESCRIPTION OF PREFERRED EMBODIMENTS

In accordance with the present invention, audio frames are sent in an overlapped manner. The number of frames to be overlapped can be fixed or adjusted dynamically. For example:

Two audio frames with one overlapped per UDP packet:

|UDP Header|Frame 1|Frame 2|Frame 3|→

|UDP Header|Frame 3|Frame 4|Frame 5|→

|UDP Header|Frame 5|Frame 6|Frame 7|→

Two audio frames with two overlapped per UDP packet:

|UDP Header|Frame 1|Frame 2|Frame 3|Frame 4|→

|UDP Header|Frame 3|Frame 4|Frame 5|Frame 6|→

|UDP Header|Frame 5|Frame 6|Frame 7|Frame 8|→

In this case, when there is packet loss in the network, the audio frame can be recovered from a subsequent packet and the audio quality can be maintained.

However, overlapped audio frames consume more network bandwidth. Therefore the selection of standard or overlapped audio format can be done dynamically. If there is high packet loss detected in the network, the format can be switched to the overlapped format from the present non-overlapped format. The number of overlapped frames can also be selected based on the seriousness of the network packet loss.

The above-mentioned audio overlapped format will be considered proprietary by the network. Gateways from other vendors will not be able to understand the format. Therefore the format has to be converted into standard audio format before being transmitted to other vendors' gateways.

Overlapped Audio→Audio Converter→Standard Audio

Audio converters are hardware, normally as a form of server, placed in the Internet. They should preferably be located close to the originating and/or terminating gateways so that the path from the converter to the gateway is short. This will minimize the possibility of packet loss in this segment. Preferably, an originating converter is in the same network as the originating gateway, and a terminating converter is in the same network as the terminating gateway. In this way the audio frames in overlapped format are transmitted between the two converters. This segment of the network is the largest and will normally cover the whole geographical distance between the two gateways. This will enable the recovery of audio frames even if there are UDP packet losses in this segment of the network, thus enabling the public Internet to the used rather than managed private networks.

Long network delay will significantly affect audio quality. If there is long delay between the PC and the terminating gateway, it will cause long delay in audio transmission, which will make normal voice conversation difficult.

Network delay is introduced as the IP packets travel through various routers on the path between the PC and gateway. In the case of the public Internet, the path is not deterministic and can't be pre-assigned. It depends on the how the ISP network connects to the public Internet backbone. If the ISP's network is a long distance from the backbone, and/or is very congested, the delay will most likely be long.

The path cannot be pre-determined, but sometimes it can be altered by making the audio stream travel through an audio re-director:

PC→Audio Re-Director→Gateway

An audio re-director can be positioned at a location in the public network so that the complete path for the audio packets to travel to the re-director and then to the gateway will incur shorter delays than if the audio packets are transmitted directly to the gateway.

In another form, the present invention also provides a number of monitoring stations which can be deployed, and which can periodically send packets to destinations of interest and measure the time that the packets take to come back to the monitoring station. From this information, various Quality of Service (QoS) metrics are measured or derived.

These QoS metrics are stored at the monitoring station(s) and are periodically uploaded to a central site(s) where the data is amalgamated.

The monitoring station(s) should be located so that they can represent the major geographic areas where calls originate and/or terminate. For the case of Internet Telephony, this information can be used for improving PC to phone, phone-to-phone, and PC-to-PC calls.

Two types of packets may be sent, depending on the destination.

a) for general destinations out of the operator's control, Internet Control Message Protocol (ICMP) ping packets are used. The data that is returned from this includes Round Trip Time (RTT) and packet loss information. In addition, Round Trip Jitter can be derived as the difference between the RTT of successive ping packets;

b) for destinations that can run some of the operator's specific software, a ping packet in accordance with the present invention will be used. This will be a variant of the Real Time transport Protocol (RTP), used by VoIP calls to transfer UDP packets, and can provide improved QoS statistics. However, it requires appropriate reflector software to be run on the destination node, which means that it cannot be used for all destinations.

In addition to the ping packets, periodic trace routes (at a lower frequency) will be performed and their results stored. This historical information will be used to detect changes in the routing of IP packets.

The results of the periodic pings will be compared with the historical values for that destination. Any discrepancy above a configurable threshold will cause the monitoring station to perform a “traceroute” to the destination. The current and historical ping statistics along with the current and historical traceroute results can then be analyzed for subsequent action and/or further investigation.

Because the statistics can be amalgamated at the central site, it will be possible to compare the measurements from various monitoring stations to a particular destination and, upon further analysis, locate the cause of the problem.

Periodic reports can also be run against the data stored in the central site to gauge the behaviour over time to a given destination. This ability to objectively detect trends in QoS metrics will allow pro-active investigation and either prevent or limit the effect of problems.

It will be possible to use the latest QoS measurements to dynamically alter the setup of VoIP calls. If the gatekeeper detects that problems are occurring to a specific IP destination, it can route traffic to alternate destinations until the problem has been resolved.

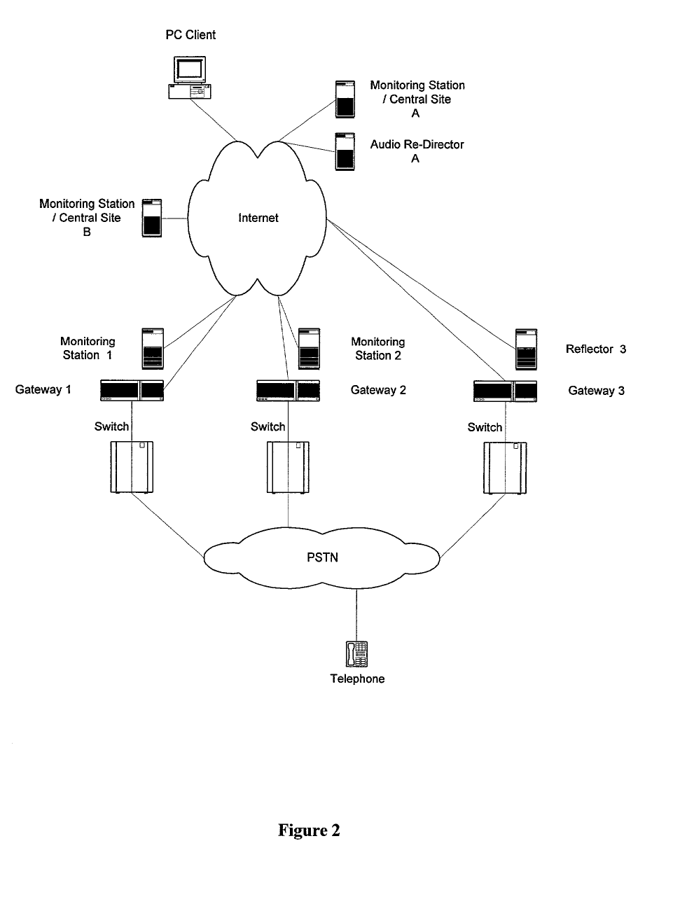

FIG. 2 shows a system having four monitoring stations (two of which are also Central Sites for amalgamating data) and one site that runs the ping reflector software.

A number of scenarios can therefore be envisaged:

a) if problems are experienced with calls between gateway 2 and gateway 3, the historical data can be viewed to determine the cause of the problem. If the problem occurs due to an intermediary IP provider, the Internet Providers at either end of the link can be requested to alter their IP routing tables to alleviate the problem;

b) if problems are detected accessing the monitoring station 1 destination (co-located with Gateway 1), calls from gateway 2 that would be routed to the Gateway 1 destination can be refused immediately, allowing gateway 2 to re-route the call via another means. This allows the operator to provide a service level to gateway 2, reducing the risk of their customers experiencing problems related to short term problems over the Internet;

c) a call from the client to a particular country can be routed to either gateway 2 or gateway 3 depending on which gateway has the best QoS parameters at that point in time;

d) a client in a particular country has problems accessing the gateway 3 destination. However, the client is able to access monitoring station A (which has a good IP route to gateway 3). In this case the client can be instructed to make a call to audio redirector A (co-located with monitoring station A), that subsequently calls gateway 3, effectively forcing the routing of IP packets to improve the QoS of the call; and

e) a report can be run against the data in the central site to detect how often the packet loss or jitter to a specific destination was above a threshold. The results from various monitoring stations can be compared to see if this is a global problem or specific to one particular geography (as shown by one particular monitoring station).

It will therefore be possible to use the same analysis tools against data collected from live calls. When a VoIP call is made, it should open two channels, a Real time Transport Protocol (RTP) channel for the audio and a Real time Transport Control Protocol (RTCP) channel for reporting QoS statistics. The RTCP QoS data for all calls can be captured and analysed to determine which destinations are experiencing QoS problems. This information can be used in conjunction with data collected by the Monitoring System to isolate faults.

Two types of methods for measuring Round Trip Time (RTT) have been suggested above.

The use of an ICMP ping has a number of drawbacks which makes the development of the specific ping of the present invention desirable. There are advantages and disadvantages of the two types of ping.

The main advantage of ICMP ping is that every node on the internet should respond to it. Therefore, it can be used to monitor the connectivity to any node without requiring special software to be deployed on that node.

The disadvantages of ICMP ping include:

a) some routers give different priority to ICMP ping packets compared to UDP packets, thereby giving a non-representative measurement of RTT. Because of this different treatment, the time taken for ICMP ping packets to get to/from a destination may not correspond to the time taken for a VoIP audio packet. This difference can vary markedly depending on the load on a router at any particular point in time. The difference between the routing of the two types of packets can result in different measurements, making the ICMP ping result different from that experienced by a time sensitive VoIP packet;

b) because of the different priority between ICMP ping and VoIP audio packets, the Jitter measured between ICMP ping packets will vary to that between VoIP packets. Because Jitter is one of the main causes of problems in the quality of VoIP (and other real time media) calls, any inaccuracies in Jitter measurement will reduce the validity of the measurement;

c) because of the dynamic nature of Internet routing tables, it is possible that the first few packets will experience a longer delay than the rest of the packets (such as while routing tables are being updated). This delay can skew the summary results returned by ICMP ping; and

d) the frequency of sending packets cannot be easily controlled. Typically, pings are sent at the rate of one packet per second, compared with one packet every sixty milliseconds or so for VoIP packets. The extra load can cause different behaviour by routers.

The advantages of the ping according to the present invention are:

a) it will use RTP packets of the same size and in the same UDP port range as those used by VoIP calls. This means that the IP network will treat the packet in exactly the same way as it treats a real VoIP packet. This applies equally to other real time media streams that typically are in the same port range as VoIP calls;

b) the setup of the call will be similar to the setup of a VoIP call. This means that when RTP measurement packets start to flow, they will experience similar behaviour as audio packets would in a real VoIP call. This makes all of the RTT and jitter measurements directly comparable to the VoIP calls being simulated;

c) the rate that packets are sent can be controlled, emulating the rate that real VoIP packets are sent. By simulating a ‘real’ VoIP call, the behaviour of the network and its effect on the packets will be more relevant;

d) the higher sampling rate provides more samples for a given time period, allowing statistically valid results (such as arithmetic mean, standard deviation and variance) to be derived in a much shorter sampling time;

e) the reflector software can measure jitter between packets arriving from the monitoring station. This allows the one way jitter measurements (monitoring station to reflector) to be compared with the overall jitter measured by the monitoring station (monitoring station to reflector and back to monitoring station). This is important if either asymmetric paths or traffic volumes exist; and

f) additional metrics such as maximum jitter, the number of consecutive packets lost, packets received out of order, and so forth, can be measured and recorded for one way and round trips.

The main disadvantage of using a ping according to the present invention is that it requires special reflector software to be run on the destination system, which requires agreement with the destination site. The reflector software is designed to have a small footprint and computational load, in addition it is portable to many operating systems, allowing it to be deployed on a general-purpose computer at the destination site.

The Real time Transport Control Protocol (RTCP) as specified in H225.0 and RTP provides a method for participants to report QoS parameters such as jitter and packet loss experienced during a VoIP call.

The QoS reported by RTCP is not as detailed as that which can be obtained by the mechanisms proposed by the present invention (in particular the jitter measurement is a smoothed average value, without any information about the maximum). It is however feasible that the RTCP data from live VoIP calls could be analysed using the same or similar tools as those used for analysing data according to the present invention, providing an indication of the QoS of live calls to a particular destination.

The monitoring methods in this proposal have the advantage over RTCP that they can also be used for pro-active detailed investigation rather than limited, post call, analysis.

The data acquisition sub-system is responsible for periodically invoking the measurement system to obtain statistics to the list of destinations.

The data retrieved will be stored in a database, along with a rolling compression of historical data to provide different views, such as for example, the previous 24 hours, previous week, previous month, previous year, and so forth. The data can be represented graphically, in addition it can be accessed programmatically to allow Quality of Service comparisons to be determined by call routing software.

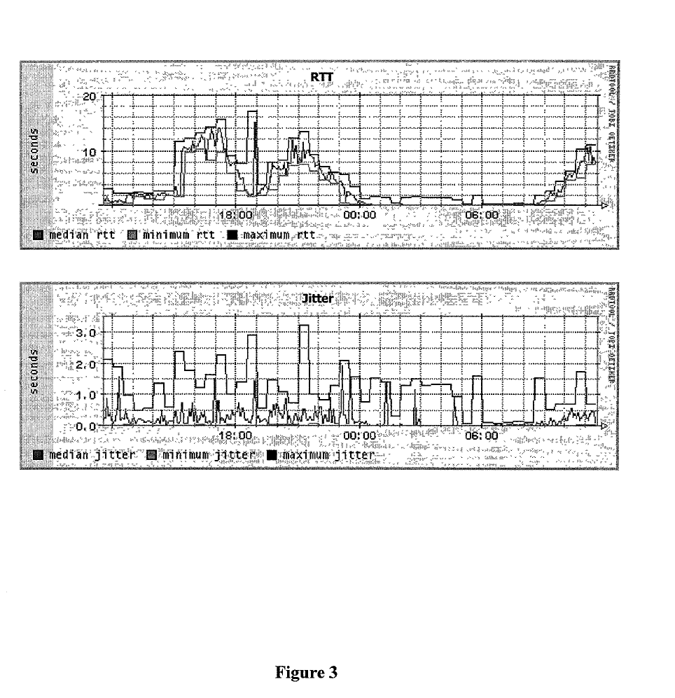

The graph in FIG. 3 shows an example of the data that can be displayed. In this case, the results of regular pings to a particular destination over a period of 24 hours. The graph shows the difference between minimum, median and maximum Round Trip Times to a particular destination, along with the associated differences in jitter.

The measurement system will be periodically called by the data acquisition subsystem and requested to invoke either a ICMP ping or a ping of the present invention (depending on the configuration file) to a list of destinations.

To avoid creating a repeating pattern of destinations, the list of destinations should be processed in a random order. It should be feasible to measure a number of destinations in parallel, however that should be carefully implemented to ensure that the different measurements do not interfere with each other.

Because an ICMP ping does not follow the ‘normal’ setup of a VoIP call, the initial packets to a particular destination will set-up the TCP/IP network route. As such, the initial packets are likely to take longer to return to the monitoring station than the later packets.

To avoid this, the RTT results from the initial packets should be discarded. The number of packets to be discarded can be calculated by analysing the time for the first packet that is returned. Rounding the number of packets up to the next second will indicate how many to discard. If the first packet (with icmp_seq 0) takes 1.5 seconds, then it is feasible that the round trip route was not complete before the second packet started to traverse the route. In this case, the first two packets should be discarded and only those packets with an icmp_seq of 2 or above should be used in the results.

Because ICMP pings are sent at the rate of one per second, only a limited number of pings from a large list can be sent before the next sampling period occurs. The trade off is that a small number of samples is not statistically large enough to derive a mean value or any derived statistics such as standard deviation or variance. Preferably, twelve pings are sent (twelve seconds per destination), this allows two to be discarded and leaves a sample size of ten.

Because of the small sample size, the arithmetic mean may not be valid (it can be skewed by one extreme measurement), therefore the median value should be used.

Other metrics that can be measured or derived include:

a) maximum RTT;

b) the number of packets lost. It must be noted that the derived percentage figure is affected by the small sample size, a loss of one packet in ten (10%) is statistically larger than one in one hundred (1%);

c) round trip jitter (derived from the RTTs of packets as they are received);

d) the number of packets received out of sequence; and

e) the number of consecutive packets lost.

To overcome the inherent limitations of the ICMP ping, it is recommended that the ping of the present invention be used as it can simulate a VoIP call setup and use RTP for ping packets, the same mechanism used by VoIP for transferring audio packets. Because RTP is also used to send other real time media streams such as video (with different payload sizes), the ping of the present invention can be used to obtain relevant statistics for other real time media streams.

The ping program will work in conjunction with a reflector program on the destination node, which will reflect the RTP ping packets back to the ping source.

The ping program will include a call setup stage, which ensures that the TCP/IP route through the Internet has been set up prior to packet times being measured.

The ping program will further use the SIP protocol (one of the protocols used for VOIP) to send a call setup request to the reflector, which will listen to a well-known port. The ping program will use SDP to format the call setup message, including:

the numbers of two UDP ports (above 5000) for receiving RTP and RTCP packets from the reflector;

an experimental RTP Payload type, as per the RTP profile for audio packets; and.

a list of summary statistics in which the ping program is interested.

The ping program will read the configuration file to determine the size of packets and the inter-packet period to send to the UDP ports specified by the reflector. It is this configuration ability that allows the ping to be used to simulate any real time media stream.

The reflector will reflect the packets to the ping program, keeping statistics on the packets that it has received (i.e. the source to destination statistics). At the end of the simulated call the reflector will send the summary statistics to the ping program.

Because the ping program sends packets at VoIP rates, it is able to gather enough samples for them to be statistically valid in a reasonably short time. It is preferred that 100 packets are sent (less than 10 seconds).

To allow the ping to be used as a stand alone diagnostic tool, it will be possible to measure a wide range of different statistics.

The ping program may measure the statistics as set-out in Table 1.

TABLE 1

| | One Way (Source - |
|---|---|
| Round Trip | Destination |
| Packets Sent | Packets Sent |
| Packets Received | Packets Received |
| Percentage packet loss for the entire | Percentage packet loss for |
| sample | the entire sample |
| Maximum number of consecutive packets | Maximum number of |
| lost | consecutive packets lost |
| Minimum Round Trip Time (RTT) | |
| Mean RTT | |
| Median RTT | |
| Maximum RTT | |
| RTT Variance | |
| The percentage number of packets that are | |
| above specified RTT thresholds (as per | |
| the destination configuration file) | |
| The number of milliseconds of RTT for | |
| packets above specified percentiles (as per | |
| the destination configuration file) | |
| Round Trip Minimum Jitter | Source - Destination |
| | Minimum Jitter |
| Round Trip Mean Jitter | Source - Destination Mean |
| | Jitter |
| Round Trip Median Jitter | Source - Destination |
| | Median Jitter |
| Round Trip Maximum Jitter | Source - Destination |
| | Maximum Jitter |
| Round Trip Jitter Variance | Source - Destination |
| | Jitter Variance |
| The percentage number of Round Trip | The percentage number of |
| packets above specified Jitter thresholds | one way packets above |
| (as per the destination configuration file) | specified Jitter thresholds |
| | (as per the destination |
| | configuration file) |
| The number of milliseconds of Jitter for | The number of milliseconds |
| specified percentiles (as per the | of one way Jitter for |
| destination configuration file) | specified percentiles (as per |
| | the destination |
| | configuration file) |
| Number of duplicate packets received | Number of duplicate |
| | packets received |
| Number of packets received out of | Number of packets received |
| sequence | out of sequence |

Regarding the Median RTT and Round Trip Median Jitter, for a large enough sample size, the median value should converge with the arithmetic mean value.

One way packet delay is not measured because to do so would require guaranteed synchronisation of the clocks on both the source and destination computers. Although the Network Time Protocol (NTP) will be used to synchronise the computers, the relative offset from absolute time cannot be guaranteed without having a direct connection to a tier one clock source, such as by equipping both computers with a GPS time source.

The thresholds in Table 1 are the number of packets above or below a given threshold value, specified in the destination list configuration file. It will be possible to specify thresholds that are:

Less Than (LT)

Greater Than (GT),

Less Than or Equal (LTE)

Greater Than or Equal (GTE).

For example, for a specified threshold of jitter LTE 30 milliseconds, the result might be 50% (of packets), while a threshold of LTE 60 milliseconds may show that 90% of packets fall within the range. The percentiles are the number of milliseconds in which a given percentile of samples fits. For example, for a specified percentile of 95 percent of jitter, the result might be 65 milliseconds (indicating that only 5 percent of the packets had jitter above 65 milliseconds).

To enable the detection of routing changes in the Internet, the monitoring stations may perform regular traceroutes to selected destinations, storing data about intermediate nodes and the typical RTT to each node. Because TCP/IP routes do not change very often, the traceroutes can be performed at a much lower rate than the pings. When problems occur, a traceroute can be initiated and the result compared to the historical values.

As part of the storage of periodic ping measurements, the network monitoring system can compare the current results to the historical averages. If alarm thresholds are exceeded the network monitoring system can perform a traceroute to the host, then advise the operator personnel.

To provide intelligent routing support, each of the monitoring stations may be combined with a distributed gatekeeper and audio redirectors to dynamically determine the best IP path to use (either directly to a gateway or via an audio redirector) to terminate a call.

The procedure outlined below is targeted at a model where audio packets to a destination gateway are sent via an audio redirector computer. The audio redirector may be co-located with the monitoring station and may be used to influence the path that packets traverse the Internet.

The monitoring station/gatekeeper may combine the current QoS statistics to a given destination gateway with a network wide routing database to determine the optimum gateway for a given request.

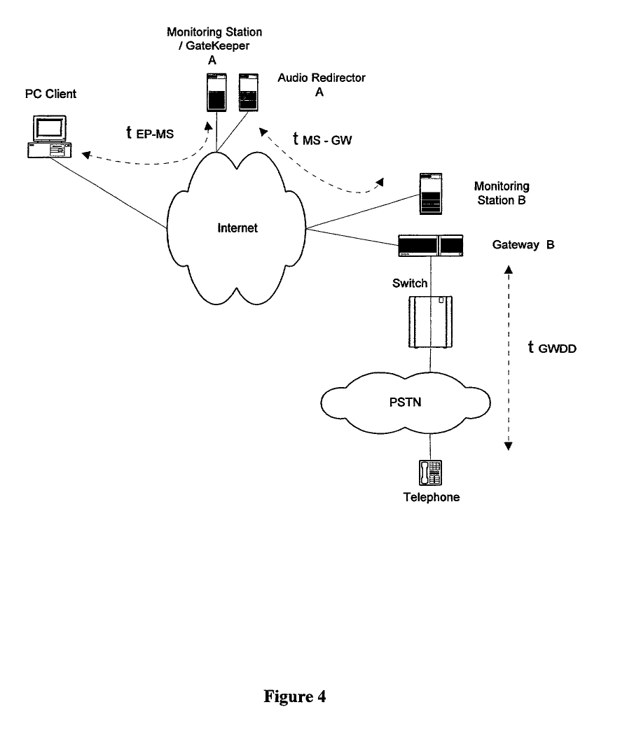

The QoS based routing would be as shown in FIG. 4.

When a user attempts to make a call, the client software would contact the monitoring station/gatekeeper(s) that is geographically closest to it. (The closest gatekeeper could be determined a priori or dynamically). It sends a request to the monitoring station/gatekeeper(s) asking for the address of a gateway to terminate a call for a given destination telephone number. The monitoring station/gatekeeper(s) use their available data, along with the long term and current QoS statistics, to determine the best destination gateway for terminating the call. (If the current QoS statistics indicate problems, then an alternate gateway can be selected).

The Round Trip delay (RTT) to the destination (a combination of the long term RTT from the monitoring station to the gateway, t_{Ms-Gw} and the gateway to destination, t_{GWDD}) is returned to the client software. The client software measures the time taken to respond to the request (t_{EP-MS}) and adds it to the RTT returned from the Monitoring Station (t_{MS-GW}+t_{GWDD)} to arrive at an estimated RTT to the destination. If the client software has queried a number of monitoring stations/gatekeepers it can compare the different RTTs to determine the best gatekeeper to request an audio redirector for the call.

Whilst there has been described in the foregoing description preferred forms of the present invention it will be understood by those skilled in the technology that many variations or modifications in specific details may be made without departing from the present invention.

1) a method of audio (as defined herein) transmission over a network where audio frames are sent in UDP packets, wherein the audio frames are overlapped by at least one for each UDP packet.

2) A method as claimed in claim 1, wherein there are two audio frames and one overlapped audio frame for each UDP packet.

3) A method as claimed in claim 1, wherein there are two audio frames and two overlapped audio frames for each UDP packet.

4) A method as claimed in of claim 1, wherein the audio frames are overlapped in response to a detection of high packet loss.

5) A method as claimed in claim 4, wherein the extent of overlap is selected based on the extent of the packet loss.

6) A method as claimed in claim 5, wherein the overlapped audio frames are converted to non-overlapped audio format by an audio converter prior to being received at a terminating gateway, the audio converter being located close to the terminating gateway.

7) A method as claimed in claim 1, wherein the overlapped audio frames are converted to non-overlapped audio format by a terminating audio converter prior to being received at a terminating gateway, the terminating audio converter being located close to the terminating gateway.

8) A method as claimed in claim 1, wherein the transmission from an originating gateway is in a non-overlapped audio format and is to an originating audio converter to convert the transmission to overlapped format; the originating audio converter being close to the originating gateway.

9) A method as claimed in claim 6, wherein the transmission from an originating gateway is in a non-overlapped audio format and is to an originating audio converter to convert the transmission to overlapped format; the originating audio converter being close to the originating gateway.

10) A method as claimed in claim 7, wherein the transmission from an originating gateway is in a non-overlapped audio format and is to an originating audio converter to convert the transmission to overlapped format; the originating audio converter being close to the originating gateway.

11) A method as claimed in claim 8. wherein the originating audio converter is in the same network as the originating gateway.

12) A method as claimed in claim 7, wherein the terminating audio converter is in the same network as the terminating gateway.

13) A method of internet telephony on a network where audio (as defined herein) frames are sent in UDP packets, wherein at least one monitoring station is provided in the network, and wherein the at least one monitoring station periodically sends at least one packet to at least one destination of interest to obtain quality of service information, the quality of service information being used to dynamically alter call set-up.

14) A method as claimed in claim 13, wherein the at least one monitoring station performs a trace route analysis at required intervals.

15) A method as claimed in claim 13, wherein the quality of service information is periodically uploaded to at least one central side for amalgamation of data.

16) A method as claimed in claim 14, wherein the quality of service information is periodically uploaded to at least one central site for amalgamation of data.

17) A method as claimed in claim 15, wherein the quality of service information obtained from a first packet sent to a first destination is compared with packet historical values for the first destination and, if a discrepancy above a predetermined threshold is obtained, a trace route analysis is performed for the first destination.

18) A method as claimed in claim 17, wherein the results of the trace route analysis are compared to trace route historical values and, if the results exceed a present level of discrepancy, traffic to the first destination can be sent over the network by a different route.

19) A method as claimed in claim 14, wherein the results of the trace route analysis are compared to trace route historical values and, if the results exceed a present level of discrepancy, traffic to the first destination can be sent over the network by a different route.

20) A method as claimed in claim 13, wherein the at least one packet has a set-up substantially the same as the set-up of a standard packet for voice over Internet protocol calls.

21) A method as claimed in claim 20, wherein the at least one packet is of the same size as those used for voice over Internet protocol calls.

22) A method as claimed in claim 20, wherein the at least one packet is in the same user data protocol port range as those used for voice over Internet protocol calls.

23) A method as claimed in claim 13, wherein there are a plurality of packets sent at a controlled rate to emulate the rate of packets of voice over Internet protocol packets.

24) A method as claimed in 17, wherein the first destination is capable of measuring jitter between packets arriving from the at least one monitoring station.

25) A method as claimed in claim 24, wherein the first destination keeps statistics on the packets it has received and forwards those statistics to the at least one monitoring station.

26) A method as claimed in claim 13, wherein the quality of service information obtained includes one or more selected from the group consisting of:
a) the maximum round trip time;
b) the number of packets lost;
c) the round trip jitter;
d) the number of packets received out of sequence; and
e) the number of consecutive packets lost.

27) A method as claimed in of claim 13, wherein prior to sending the at least one packet, the at least one monitoring station sends a call set-up request.

28) A packet to be used to provide quality of service information about a telecommunications network, the packet having a set-up substantially the same as the set-up of a standard packet for voice over Internet protocol calls.

29) A packet as claimed in claim 26, wherein the packet is of the same size as the standard packet.

30) A packet as claimed in claim 26, wherein the packet is in the same user data protocol port range as the standard packet.

31) A packet as claimed in claim 26, wherein the packet is sent over the telecommunications network to emulate the standard packet.

32) A packet as claimed in claim 26, wherein the packet emulates a typical packet in a real time media stream.

33) A packet as claimed in claim 26, wherein the packet is of the same size and user data protocol port range as the standard packet.

34) A packet as claimed in clam 33, wherein the packet is sent over the telecommunication network to emulate the standard packet.
